(19) United States
(12) Patent Application Publication
(10) Pub. No.: US 2007/0280285 A1
(43) Pub. Date: Dec. 6, 2007

(54) METHOD AND SYSTEM OF FIELD DEVICE PROTOCOL MASKING

(75) Inventors: RICHARD J. VANDERAH, MARSHALLTOWN, IA (US); RYAN A. BRYNGELSON, MARSHALLTOWN, IA (US); SCOTT A. GRIFFIN, COLO, IA (US)

Correspondence Address: CONLEY ROSE, P.C.;David A. Rose, P. O. BOX 3267, HOUSTON, TX, 77253-3267, US

(73) Assignee: DANIEL MEASUREMENT & CONTROL, INC., HOUSTON, TX (US)

(21) Appl. No.: 11/422,434

(22) Filed: Jun. 6, 2006

(51) Int. Cl. H04J 3/16

(52) U.S. Cl. 370/466; 370/392

(57) ABSTRACT

A method and related system of a method and system of field device protocol masking. At least some of the illustrative embodiments are methods comprising receiving a message in a first protocol format from a field device of a control system, modifying the message to create a modified message (the modified message in a second protocol format), and forwarding the modified message to an upstream device that communicates using the second protocol.

### BACKGROUND

A growing trend in process control is distributed process control. Rather than having a single, centralized control center sending control commands to remote locations, the control functionality is moved closer to the controlled equipment. The centralized control center takes a more supervisory role in the process control. For example, rather than sending a continuous stream of valve position commands to a valve controlling flow, the centralized control center sends a single flow set point to a remote process controller proximate to the valve. The remote process controller makes valve position adjustments to achieve and maintain the desired flow. The centralized control center in distributed process control systems may be referred to as a supervisory control and data acquisition (SCADA) system. FIG. 1 illustrates a related art system in which a SCADA system 10 couples to a remote process controller 12 through a communication channel 14.

Many of the field devices used to implement a distributed control system are processor-based devices. Thus, not only do these systems perform their control and/or measurement tasks, but may also be able to perform self diagnostics and keep track of parameters of interest such as serial number of the device, last calibration date of the device, measurement drift experienced by the device, internal errors that may lead to failure of the device, to name a few. For this reason, many process control systems also implement an asset management system 16, which system 16 communicates with the field devices to obtain asset management data. However, the communication protocol of some field devices is different than the communication protocol implemented by the asset management system. Thus, in the related art some field devices, though an important part of the controlled process, may not be visible on the asset management system 16.

### SUMMARY

The problems noted above are solved in large part by a method and related system of a method and system of field device protocol masking. At least some of the illustrative embodiments are methods comprising receiving a message in a first protocol format from a field device of a control system, modifying the message to create a modified message (the modified message in a second protocol format), and forwarding the modified message to an upstream device that communicates using the second protocol.

Other illustrative embodiments are systems comprising a processor, a first communication port coupled to the processor (the first communication port configured to couple to an asset management system by way of a first communication channel), a second communication port coupled to the processor (the second communication port configured to couple to a field devices of a control system). The processor is configured to receive a message from the asset management system in a first protocol over the first communication port, translate the message to a second protocol to create a translated message, and forward the translated message to a field device over the second communication port.

Yet still other illustrative embodiments are systems comprising a first computer system (itself comprising one or more software packages selected from the group: a data acquisition system software package; and a control system software package), a second computer system comprising a software package to monitor health and status of fielded devices remotely located from the second computer system, a first communication channel coupled to each of the first and second computer systems, a plurality of fielded devices, and an intermediate device having a first port coupled to the first communication channel and a second port coupled to the second communication channel. The intermediate device is configured to receive a message in a first protocol format from a field device of the plurality of field devices, modify the message to create a modified message in a second protocol format, and forward the modified message to the asset management system.

Yet still other illustrative embodiments are computer-readable media storing a program that, when executed by a processor, perform a method comprising receiving a message in a first protocol format from an asset management system of a control system, modifying the message to create a modified message (the modified message in a second protocol format), and forwarding the modified message to a field device that communicates using the second procol.

The disclosed devices and methods comprise a combination of features and advantages which enable it to overcome the deficiencies of the prior art devices. The various characteristics described above, as well as other features, will be readily apparent to those skilled in the art upon reading the following detailed description, and by referring to the accompanying drawings.

### BRIEF DESCRIPTION OF THE DRAWINGS

For a detailed description of the preferred embodiments of the invention, reference will now be made to the accompanying drawings in which:

FIG. 1 illustrates a related art system;

FIG. 2 illustrates a system constructed in accordance with at least some embodiments of the invention;

FIG. 3 illustrates a field server in accordance with at least some embodiments of the invention;

FIG. 4 illustrates message packets from two different communication protocols, and the correspondence of the various portions of those message packets; and

FIG. 5 illustrates a method in accordance with at least some embodiments of the invention.

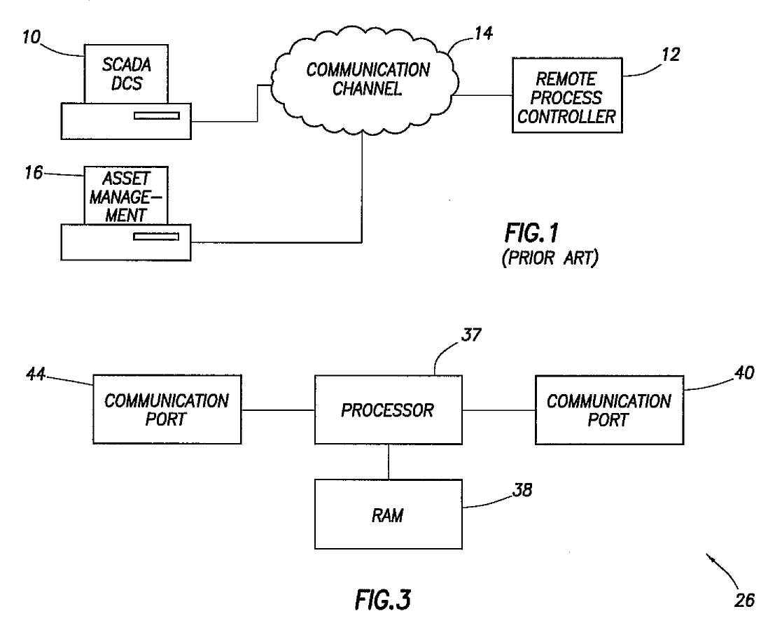

### NOTATION AND NOMENCLATURE

Certain terms are used throughout the following description and claims to refer to particular system components. This document does not intend to distinguish between components that differ in name but not function.

In the following discussion and in the claims, the terms “including” and “comprising” are used in an open-ended fashion, and thus should be interpreted to mean “including, but not limited to . . . ”. Also, the term “couple” or “couples” is intended to mean either an indirect or direct connection. Thus, if a first device couples to a second device, that connection may be through a direct connection, or through an indirect electrical connection via other devices and connections.

### DETAILED DESCRIPTION

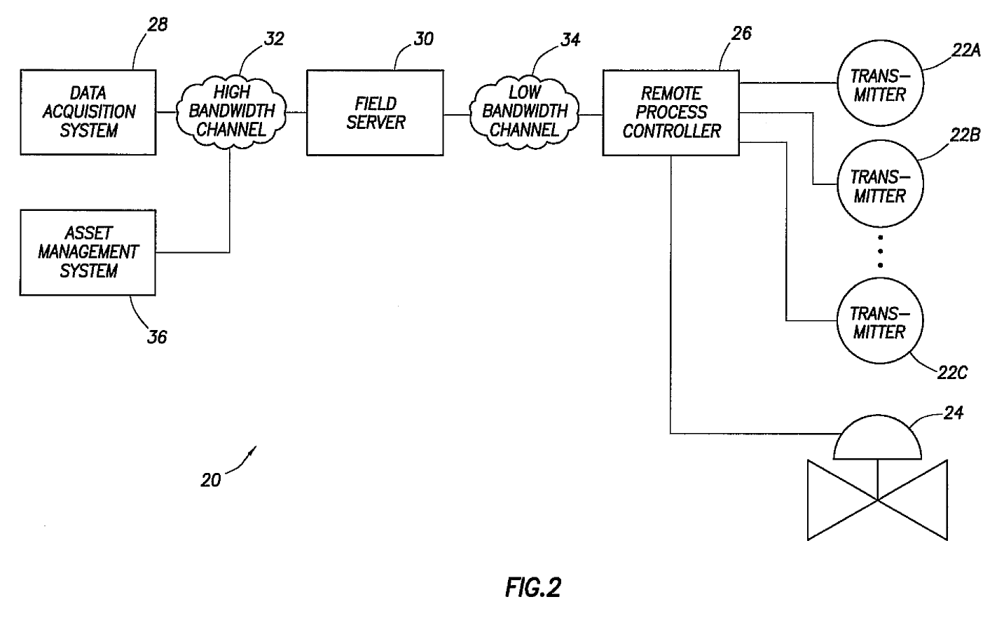

FIG. 2 illustrates a system 20 constructed in accordance with at least some embodiments of the invention. In particular, FIG. 2 shows a plurality of field devices, in this illustrative case being transmitters 22 and control valve 24. The transmitters 22 could be, for example, pressure transmitters, flow transmitters and/or temperature transmitters which measure their respective field parameters and provide that measurement data to the field controller or remote process controller 26. Based at least in part on the data received from the transmitters 22, the remote process controller 26 controls field devices, such as by providing valve position commands to the illustrative control valve 24. A system comprising one or more transmitters 22 and control valve 24 is merely exemplary. Remote process controllers 26 in accordance with embodiments of the invention may couple to any number of field measurement devices and field control devices, and further may be programmed to execute many process control scenarios (e.g., control loops based on measurement data, and batch process control). Moreover, a system may comprise a plurality of remote processor controllers. Remote process controller 26 may be, for example, a ROC809 remote operations controller available from Emerson Process Management of St. Louis, Mo.

Still referring to FIG. 2, system 20 further comprises a data acquisition system 28 coupled to the remote process controller 26. The data acquisition system 28 may take many forms (e.g., a data acquisition software package, a process control software package, and/or a supervising control and data acquisition (SCADA) software package). These software systems may execute on the same computer system, or on different computer systems. Regardless of the precise form of the data acquisition system 28, these systems obtain measurement data from field devices and remote processor controller 26, and likewise send process control commands to the field devices and/or the remote process controller 26, However, the remote process controller 26, and field devices such as transmitters 22 and control valve 24 may be located tens, hundreds or thousands of miles from the physical location of the data acquisition system 28. To address difficulties of the extended distance, and in accordance with some embodiments of the invention, the data acquisition system 28 couples to the remote process controller 26 through a field server 30.

Field server 30 couples to the data acquisition system 28 by way of a high bandwidth channel 32. In accordance with some embodiments, the high bandwidth channel 32 is an Ethernet network supporting 10 megabits per second data throughput or greater and implementing TCP/IP as the physical layer protocol. In alternative embodiments, the high bandwidth channel may be an Internet connection, a local area network (LAN), a wide area network (WAN), a relatively high bandwidth radio connection, a dedicated telephone network connection (e.g., a T1 connection), and other similar relatively high bandwidth connections. The field server 30 couples to the remote process controller 26 by way of a low bandwidth communication channel 34. Inasmuch as the remote process controller 26 may be located proximate to the field operations and may be many miles from the physical location of the field server 30, the low bandwidth connection may be any available communication channel to inexpensively span the distance between the field server 30 and the remote process controller 26, such as a dial-up or leased phone line connection, cellular phone, GSM or GPRS, radio, a satellite communication system, or a combination of these. The low bandwidth communication channel 34 may have a data throughput of 256 kilo-bits per second or less in some embodiments.

Still referring to FIG. 2, the field devices, such as transmitters 22, measure field parameters and create measurement data that is provided to the remote process controller 26. The exemplary transmitters 22 couple to the remote process controller 26 by way of 4-to-20 mA current loops, wherein the electrical current drawn by each transmitter 22 is directly proportional to the measured field parameter. In accordance with alternative embodiments of the invention, the transmitters 22 may be highway addressable remote transducer (HART®) compatible, and thus in addition to or in place of a value indicated by the 4-to-20 mA signal, the transmitters may digitally communicate their measurement data to the remote process controller. Use of a 4-to-20 mA current loop or HART digital communications is merely exemplary, and other communication systems and protocols may be equivalently used between the remote process controller 26 and field devices, such as Foundation FieldBus and/or the MODBUS protocols.

Still referring to FIG. 2, a process control system 20 may also have an asset management system 36. An asset management system may be a computer system implementing a software package that gathers and maintains health, status and configuration data regarding a process control system, including status and configuration data from field devices such as transmitters 22. Status data may comprise information such as transmitter health, internal diagnostics, input voltage, current input, current output, communications health, and configuration changes. Configuration data may comprise information such as serial numbers, calibration dates, calibration parameters, tuning parameters, generic text messages, instrument materials constructions, instrument sensor ranges, instrument input signal ranges, instrument output signal ranges, and alarm set points. This information may be helpful in troubleshooting failures of a process control system and/or implementing preventative maintenance programs. In some embodiments, the asset management system 36 may comprise the AMS™ Suite series of products available from Emerson Process Management.

In order to gather the status and configuration data, the asset management system 36 communicates with field devices. Field server 30 and the remote process controller 26 may act as message routers directing requests for information to the appropriate field device, and likewise returning the requested information from the field device to the asset management system. In accordance with embodiments of the invention, the asset management system 36 communicates with field devices using only particular protocols. For example, an asset management system 36 from may assume that all the field devices communicate using HART protocol or Foundation FieldBus protocol. However, there may be situations where the field devices, such as one or more of the transmitters 22, communicate using a protocol not supported by the asset management system 36. In the illustrative case of an AMS™ Suite series of products available from Emerson Process Management, these products may not support communication to field devices implementing MODBUS protocol. In accordance with embodiments of the invention, however, field devices that communicate using protocols not supported by the asset management system 36 may still be accessed by the asset management system 36 by having the remote process controller 26 and/or field server 30 perform protocol translation. The remaining discussion assumes that the field server 30 performs the protocol translation; however, the protocol translation could be equivalently performed in the remote process controller 26, or the translation split between the field server 30 and the remote process controller 26.

FIG. 3 shows an electrical block diagram of a field server 30 in accordance with embodiments of the invention. In particular, the field server may comprise a processor 37 coupled to random access memory (RAM) 38. The processor 37 may take many forms. In some embodiments, the processor may be a microcontroller, and thus the RAM 38 functionality, along with other components such as read only memory (ROM) and communications capabilities, are integrated on a single semiconductor die. In alternative embodiments, the processor 37 is a standalone processor (e.g., a processor manufactured by Intel®, Freescale/Motorola and/or AMD), and thus may be coupled to other individual components, such as the RAM 38. Moreover, processor 37 may be an application specific integrated circuit (ASIC), a field programmable gate array (FPGA), and/or system on a chip. Regardless of the precise nature of the processor 37, the processor may be programmed to perform desired functions such performing protocol translations between field devices and the asset management system 36.

The processor 37 couples to and communicates with the remote process controllers 26 by way of a communication port 40. The precise nature of the communication port 40 depends on the type of connection to the remote process controller 26. For example, if the field server 30 communicates to the remote process controller 26 by way of a dedicated serial communication pathway, the communication port 40 may be a universal asynchronous receiver transmitter (UART) device. In alternative embodiments where the low bandwidth communication channel 34 is a cellular phone connection, the communication port 40 may be a device capable of interfacing with cellular telephone equipment. Likewise, if the low bandwidth communication channel 34 is a radio or satellite communication channel, then the communication port 40 may be a system capable of interfacing with a radio control or satellite control respectively.

Still referring to FIG. 3, the remote process controller 26 may further comprise yet another communication port 44 coupled to the processor 37. Communication port 44 allows the processor 37 to communicate with upstream devices, such as the data acquisition system 28 and asset management system 36 (of FIG. 2). In some embodiments, the communication port 44 may be a device configured to communicate by way of an Ethernet network, whether coupled directly to the asset management system 16, or through one or more local area networks, wide area networks and/or other devices such as routers.

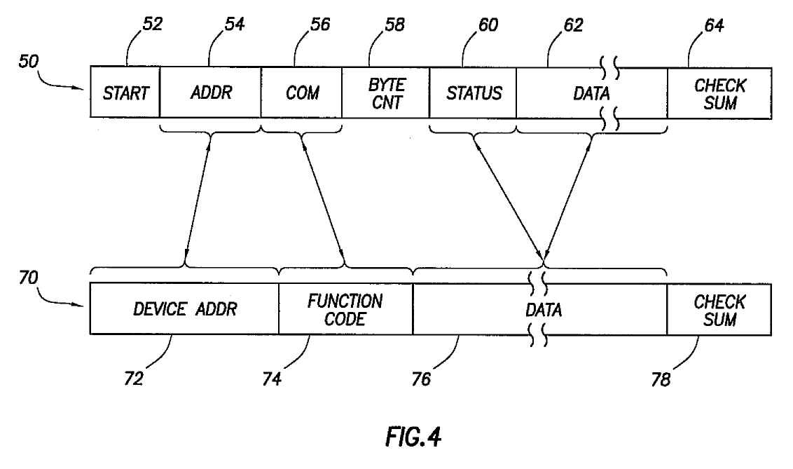

Consider, for purposes of explanation, an asset management system 36 which communicates to field devices using HART protocol, and which is not programmed to communicate using the MODBUS protocol. Further consider a field device (e.g. transmitter 22A) that communicates using the MODBUS protocol, and which is not programmed to communicate using HART protocol. In spite of these differences in communication protocol, and accordance with the embodiments of the invention, the asset management system 36 nonetheless communicates to the transmitter 22A with the field server 30 performing protocol translation. FIG. 4 shows the message format for an illustrative HART message. In particular, HART message 50 comprises a start character 57, one or more bytes comprising the address 54 of the source and destination, one or more command (corn) bytes 56, a byte count 58 for the message, two bytes of status information 60 (if the communication is from the secondary device to the primary device), a plurality of data byes 62 and a check sum 64. This and other information regarding the illustrative HART communication protocol may be obtained from the HART Communication Foundation of Austin, Tex.

FIG. 4 also shows an illustrative MODBUS message 70. In particular, the illustrative MODBUS message format may have one or more bytes comprising the destination device address 72, one or more bytes defining a function code 74 which defines a message type, one or more bytes with data 76 and other information, and a check sum block 78. This and other information regarding the illustrative MODBOS communication protocol may be obtained from the MODBUS-IDA headquarters in North Grafton, Mass.

In the illustrative case where the asset management system 36 uses the HART protocol and the transmitter 22A uses the MODBUS protocol, the field server 30 (or in an alternative embodiments the remote process controller 26) performs protocol translation between the two message formats. For example, for a message originating at the asset management system and directed to the transmitter 22A, the address of the destination device is extracted from the address bytes 54 of the HART message 50 and placed in the device address 72 portion of the MODBUS message 70. The one or more bytes comprising the command 56 portion of the HART message 50 are translated into appropriate function codes 74 in the MODBUS message 70. Likewise, the status information in the status 60 portion of HART message and the data 62 are translated into an appropriate format in the data 76 portion of MODBUS message 70. Finally, a new check sum 78 may be calculated with regard with the remaining bytes of the message and placed in the check sum 78 portion of the MODBUS message 70. From there, the field server 30 forwards the message to the transmitter 22A through the remote process controller 26. In accordance with at least some embodiments, even though the field server 30 performs the protocol translation, the communication protocol between the field server 30 and the remote process controller 26 may be different than either the protocol used by the asset management system 36 or the transmitter 22A. In these embodiments, after translating the message format, the modified message format (in this case the MODBUS format) may itself be “wrapped” in some other protocol for transmission across the low bandwidth communication channel 34. For example, the field server 30 and the remote process controller 26 may communicate using the ROC protocol, a proprietary communication protocol of Emerson Process Management.

When the modified message arrives at the remote process controller 26, the remote process controller forwards the message to the transmitter 22A, in some cases after “unwrapping” the modified message from the communication protocol used between the field server 30 and the report process server controller.

Still referring to FIG. 4, most communications between the asset management system. 36 to a field device such as transmitter 22A are request/response. Thus, after receiving a message from the asset management system, the field device immediately returns the requested data. Thus, still considering the embodiments where the message protocol of the asset management system 36 is different than a transmitter 22A, in this request/response the transmitter 22A sends a response in the protocol in which it communicates (in this illustrative situation the MODBUS protocol). The remote process controller 26 forwards the message to the field server 30 (possible wrapped in a communication protocol used when communicating across the low bandwidth communication 34). The field server 30 translates the protocol into a message format suitable for communication to the asset management system 36 (e.g. HART protocol). After protocol translation field server 30 forwards the message to the asset management system 36. Thus, the asset management 36 is able to communicate with field devices that utilize a different communication protocol. An asset management system 36 using HART as the communication protocol and a field device using a MODBUS as a communication protocol is merely illustrative. Any asset management system 36 and field device 22A using protocols of any variety, where those protocols are different, may be equivalently used.

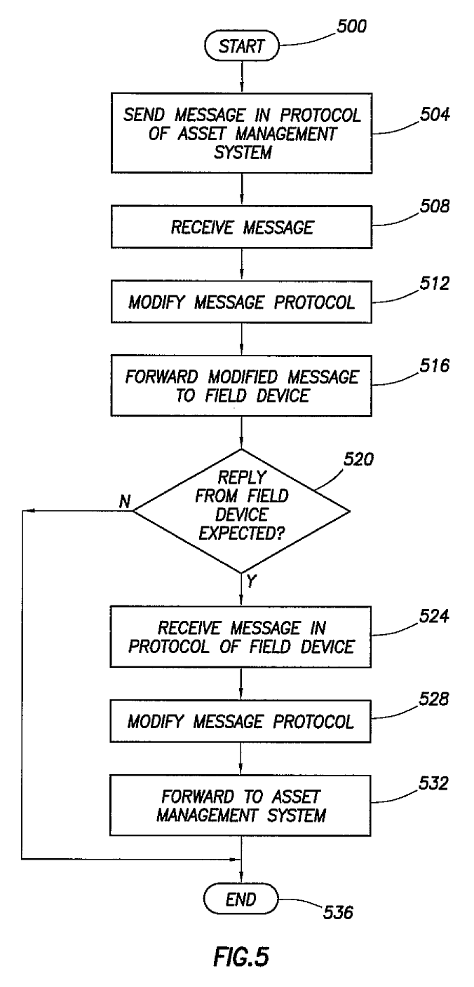

Turning now to FIG. 5, FIG. 5 illustrates a method in accordance with the embodiments of the invention. In particular, the illustrative methods starts (block 500) and moves to the asset management system 36 sending a message in the protocol used by the asset management system (block 504). In accordance with at least some embodiments, the asset management system 36 uses the HART or Foundation Fieldbus protocol. The message is received (block 508), such by the field server 30 (or in embodiments that do not use a field server 30 the remote process controller 26). After receipt of the message in the protocol of the asset management system, the protocol of the message is modified (block 512). As noted above, the translation or modification of the protocol of the message from the asset management system may be performed in the field server 30 or the remote process controller 26. After modification, the message is forwarded to the field device (block 516).

Still referring to FIG. 5, if no reply is expected from the field device (block 520), then the process ends (block 536). If, on the other hand, a reply message is expected, then the illustrative method moves to receiving a message in the protocol of the field device (block 524). In accordance with at least some embodiments, the field device may use the MODBUS protocol, but any message protocol may be equivalently used. After receipt of the message in the protocol of the field device, the message protocol is modified (block 528). This modification may be completed in the field server 30, the remote process controller 26 or a combination of the two. After modification, the message is forwarded to the asset management system (block 532). Thus, the modification of the message illustrated by block 528 may be modifying the message to be in a HART protocol where the asset management system 36 communicates using the HART protocol. Although the illustrative embodiments of FIG. 5 are shown with respect to a request/response format communication, it is possible for a field device to send unsolicited data to the asset management system 36. In this case, the illustrative method begins at block 524.

From the description provided herein, those skilled in the art are readily able to combine software created as described with appropriate general purpose or special purpose computer hardware to create a computer system and/or computer subcomponents embodying the invention, to create a computer system and/or computer subcomponents for carrying out the method of the invention, and/or to create computer-readable media for storing a software program to implement the method aspects of the invention.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A method comprising:
receiving a message in a first protocol format from a field device of a control system;
modifying the message to create a modified message, the modified message in a second protocol format; and
forwarding the modified message to an upstream device that communicates using the second protocol.

2. The method as defined in claim 1 wherein receiving further comprises receiving the message from a field device being one selected from the group: a pressure transmitter; a differential pressure transmitter; a temperature transmitter; a level transmitter; and a flow meter.

3. The method as defined in claim 1 wherein forwarding further comprises forwarding the modified message to an asset management system.

4. The method as defined in claim 1 wherein receiving the message further comprises receiving the message with the first protocol being one selected from the group: a message protocol associated with Foundation fieldbus standard; the Modbus protocol; the message protocol associated with Foundation fieldbus standard enveloped in a third protocol; and the Modbus protocol enveloped in the third protocol.

5. The method as defined in claim 1 wherein modifying further comprises modifying to create the modified message in the second protocol being the highway addressable remote transducer (HART) protocol.

6. The method as defined in claim 1 further comprising, prior to the receiving, modifying and forwarding:
sending a request message in the second protocol format from the upstream device;
modifying the request message to create a modified request message, the modified request message in the first protocol; and forwarding the modified request message to the field device.

7. A system comprising:
a processor;
a first communication port coupled to the processor, the first communication port configured to couple to an asset management system by way of a first communication channel;
a second communication port coupled to the processor, the second communication port configured to couple to field devices of a control system;
wherein the processor is configured to receive a message from the asset management system in a first protocol over the first communication port translate the message to a second protocol to create a translated message, and forward the translated message to a field device over the second communication port.

8. The system as defined in claim 7 wherein the processor is configured to receive the message from the asset management system in the first protocol being a highway addressable remote transducer (HART) protocol.

9. The system as defined in claim 8 wherein the processor is configured to receive the message in HART protocol enveloped in a third protocol.

10. The system as defined in claim 7 wherein the processor is configured to translate the message to the translated message in the second protocol being one selected from the group: the message protocol associated with Foundation fieldbus standard; the Modbus protocol; the message protocol associated with Foundation fieldbus standard enveloped in a third protocol; and the Modbus protocol enveloped in the third protocol.

11. A system comprising:
a first computer system comprising one or more software packages selected from the group: a data acquisition system software package; and a control system software package;
a second computer system comprising a software package to monitor health and status of field devices remotely located from the second computer system;
a first communication channel coupled to each of the first and second computer systems;
a plurality of field devices;
a second communication channel coupled to the plurality of field devices; and
an intermediate device having a first port coupled to the first communication channel, and a second port coupled to the second communication channel;
wherein the intermediate device is configured to receive a message in a first protocol format from a first field device of the plurality of field devices, modify the message to create a modified message in a second protocol format and forward the modified message to the asset management system.

12. The system as defined in claim 11 wherein the first field device sends the message in the first protocol being one selected from the group: a message protocol associated with Foundation fieldbus standard; or the Modbus protocol.

13. The system as defined in claim 12 wherein the intermediate device receives the message in the first protocol enveloped in a third protocol.

14. The system as defined in claim 11 wherein the intermediate device is configured to modify the message to create the modified message in the second protocol being the highway addressable remote transducer (HART) protocol.

15. The system as defined in claim 14 wherein the intermediate device is configured to create the modified message, and envelope the modified message in a third protocol prior to sending the message to the asset management system.

16. The system as defined in claim 11 wherein the first field device is one selected from the group: a pressure transmitter; a differential pressure transmitter; a temperature transmitter; a level transmitter; and a flow meter.

17. A computer-readable media storing a program that, when executed by a processor, performs a method comprising:
receiving a message in a first protocol format from an asset management system of a control system;
modifying the message to create a modified message, the modified message in a second protocol format; and
forwarding the modified message to a field device that communicates using the second protocol.

18. The method as defined in claim 17 wherein forwarding further comprises forwarding the modified message to the field device being one selected from the group: a pressure transmitter; a differential pressure transmitter; a temperature transmitter; a level transmitter; and a flow meter.

19. The method as defined in claim 17 wherein modifying the message further comprises modifying the message to create the modified message with the second protocol being one selected from the group: a message protocol associated with Foundation fieldbus standard; the Modbus protocol; the message protocol associated with Foundation fieldbus standard enveloped in a third protocol; and the Modbus protocol enveloped in the third protocol.

20. The method as defined in claim 17 wherein receiving further comprises receiving the message from the asset management system in the first protocol being the highway addressable remote transducer (HART) protocol.
